(19) United States
(12) Patent Application Publication
(10) Pub. No.: US 2010/0272162 A1
(43) Pub. Date: Oct. 28, 2010

(54) Synchronous serial programmable interface

(75) Inventors: Claire Simeon, Milpitas, CA (US); Ronak Patel, Sunnyvale, CA (US); Mark N. Fullerton, Austin, TX (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/604,193

(22) Filed: Oct. 22, 2009

Related U.S. Application Data
(60) Provisional application No. 61/172,811, filed on Apr. 27, 2009.

(51) Int. Cl. H04B 1/38

(52) U.S. Cl. 375/220

(57) ABSTRACT

A synchronous serial programmable interface that programmably defines a plurality of frame definitions in which each frame definition provides signal timing for a corresponding frame used in serial data transfer. A sequencer module is used to provide a plurality of instructions, in which each instruction, when executed, obtains a frame definition from the plurality of frame definitions. Then a task scheduler selects a scheduled task from a plurality of tasks that are used in transferring data. The particular task selects one or more instructions from the plurality of instructions and obtains one or more frame definitions specified by the instruction or instructions to establish one or more frames that are used in transferring the data.

### CROSS REFERENCE TO RELATED APPLICATION

This application claims the benefit of priority to U.S. Provisional Patent Application having an application No. 61/172,811, filed Apr. 27, 2009, and titled “Synchronous serial programmable interface” which is incorporated herein by reference in its entirety.

### BACKGROUND OF THE INVENTION

1. Technical Field of the Invention

The embodiments of the invention relate to communications and more particularly to a programmable interface for transfer of data.

2. Description of Related Art

Synchronous and asynchronous interfaces are generally known for transferring data between two locations, such as between circuits, devices, integrated circuit chips, circuit boards, etc. In one particular class of operation, the two interfaces may operate as a master and a slave. A synchronous serial interface usually refers to a 4-wire connection between master and slave devices. The master is defined as the side driving a clock line and a control signal (which may be called Chip Select [CS], or some other name) line. The other two lines are for serial data transmission (TX) and data reception (RX). Both the master device and the slave device drive respective data on the TX line and receive respective data on the RX line. That is, the master's TX line corresponds to the slave's RX line and the slave's TX line corresponds to the master's RX line. Sometimes, RX and TX lines may be merged and made bidirectional, so that the TX and RX functions for both the master and slave are achieved on one line. In this instance, the interface operates as a 3-wire interface.

Although a variety of synchronous serial data interface devices are currently available, these interfaces are designed for a particular application and function to operate supporting one data transfer scheme, protocol, standard, etc. Typically, synchronous serial data interfaces are not readily adaptable for different applications, standards, protocols, etc. Therefore, there is a need for a more flexible interface that allows programmability for a variety of applications and to accept different data transfer schemes, standards, protocols, etc.

### SUMMARY OF THE INVENTION

The present invention is directed to apparatus and methods of operation that are further described in the following Brief Description of the Drawings, the Detailed Description of the Invention, and the Claims. Other features and advantages of the present invention will become apparent from the following detailed description of the embodiments of the invention made with reference to the accompanying drawings and claims.

### BRIEF DESCRIPTION OF THE DRAWINGS

FIG. 1 is a block schematic diagram showing an embodiment of a synchronous serial programmable interface (SSPI) device of the present invention.

FIG. 2 is a block diagram showing signal connections for the SSPI device of FIG. 1 between an internal SOC bus and an external connection in one embodiment for practicing the invention.

FIGS. 3A-3H show various block diagrams that illustrate example master-slave configurations for using the SSPI device of FIG. 1.

FIG. 4 shows an example of a frame in master mode.

FIG. 5 shows an example of a frame in slave mode.

FIG. 6 is a flow chart showing an example process flow for a sequencer.

FIG. 7 shows an example of an eight-task operation performed by a task scheduler.

FIG. 8 is a flow chart showing an example process flow for a task scheduler.

FIG. 9 is a diagram showing an example of combining frame definitions into a sequence by use of instructions.

FIG. 10 is a diagram showing an example of combining more than one sequence.

FIG. 11 shows starting values associated with frame definition.

FIG. 12 shows ending values associated with frame definition.

### DETAILED DESCRIPTION OF THE INVENTION

The embodiments of the present invention may be practiced in a variety of settings that utilize a synchronous serial interface to transmit and/or receive information, such as data. The various embodiments described below may be implemented as a stand-alone interface, integrated within a chip that contains other circuits (such as a processor) that provide other functions, integrated within an integrated circuit chip that provides a complete system (commonly referred to as a system-on-chip or SOC), or in some other environment. There may also be only one serial interface device or multiple interface devices that implement an embodiment or embodiments of the invention in a given chip. The various embodiments of the Synchronous Serial Programmable Interface (SSPI) described below pertain to a master/slave scheme. However, the invention may be readily adapted to other data transfer schemes as well. Thus, the embodiments described below are for exemplary purpose and other embodiments may be readily implemented to practice the invention.

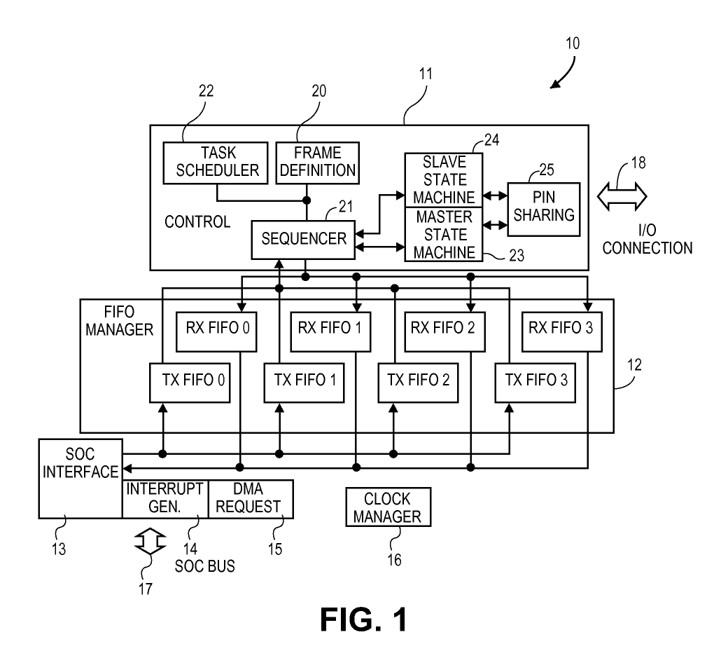

FIG. 1 shows functional blocks for implementing a Synchronous Serial Programmable Interface (SSPI) device 10 that incorporates the present invention. SSPI device 10 includes a control module 11, First-In-First-Out (FIFO) manager module 12 and various other subsidiary modules and interfaces that may or may not be present in some embodiments. Thus, SSPI device 10 of FIG. 1 is just one embodiment for practicing the invention.

As noted above, SSPI device 10 may be stand-alone or integrated in a chip with other circuits and components. For the embodiments described below, SSPI device 10 (hereinafter simply noted as SSPI 10) is implemented within an integrated circuit with circuits that provide other functions and the integrated circuit may be a SOC. When integrated in a chip in this fashion, a processing component (such as a processor or controller) is also present in the chip and SSPI 10 is used to send and receive serial data synchronously with devices that couple to the chip containing SSPI 10. Thus, Input/Output (I/O) connection (or interface) 18 shown is one means of providing this connection external to the chip containing SSPI 10. Similarly, SOC bus 17 is shown as an internal bus coupling SSPI 10 to other internal chip components. For example, SOC bus 17 may be an internal bus that communicates with an on-chip processor or memory.

Control module 11 includes a frame definition module 20, sequencer module 21, task scheduler module 22, master state machine module 23, slave state machine module 24 and pin sharing module 25. FIFO manager module 12 includes a plurality of RX and TX FIFO units (shown as RX FIFO 0-3 and TX FIFO 0-3). In this example, four sets of RX and TX FIFOs are shown. In other embodiments, the number of TX and/or RX FIFOs may vary. The FIFOs may be actual physical units or employed as logical units. Although the data storage is shown as a FIFO, a variety of storage devices, such as buffers, memory, stacks, etc., may be used in other embodiments and maybe used with a variety of data transfer techniques. SSPI 10 also includes a SOC interface module 13, interrupt generation module 14, Direct-Memory-Access (DMA) request module 15 and a clock manager module 16. It is to be noted that other modules may be present in other embodiments.

Although a more detailed description is provided below for the control module 11, a brief introduction is provided here for the blocks of control module 11. Task scheduler module 22 enables a round robin operation for the tasks from its predefined set of tasks that are stored in a task table by running the tasks one at a time. A task is mainly defined by the resources it is using, such as a specific frequency slave clock SCLK, a unique chip select CS control signal, a unique RX line, a unique TX line, etc.

Sequencer module 21 includes a sequencer table and surrounding logic that presents to the master and slave control blocks 23, 24 a frame or frames that are to be sent out. The logic cycles through a program of instructions written in the sequencer table, in which the sequence of instructions allows associating dynamically transmit data (TXDATA) with one of the logical TX FIFO, receive data (RXDATA) with one of the logical RX FIFO, dynamically disabling transmission or reception on one frame and repeating a same frame pattern.

Frame definition module 20 contains the various frame definitions that may be employed in sending data. The frame definitions are programmable, allowing for frames to be defined depending on a particular data transfer scheme, standard, protocol, etc. (hereinafter, simply referred to as protocol) being implemented for data transfer. The frame definitions are used by sequencer module 21 when instructions in the sequencer module 21 calls forth a given frame definition or definitions.

Master state machine module 23 generates the timing as seen on connection 18, according to one of the frame definitions from the frame description table within frame definition module 20 and other information provided by sequencer module 21 and task scheduler module 22. Master state machine module 23 also contains a parallel to serial converter for TXDATA and serial to parallel converter for RXDATA. Although a state machine is shown for providing the master functions of a master-slave unit, other circuitry and techniques may be used for providing similar master mode functions.

Slave state machine module 24 uses the clock from SCLK to perform similar operations as the master, but for the slave function. Again, although a state machine is shown for providing the slave functions of a master-slave unit, other circuitry and techniques may be used for providing similar slave mode functions.

Pin sharing module 25 allows the dispatch of control signal from Master/Slave modules 23, 24 to expected chip select (CS) and TX pins, and sends appropriate RX data to the state machines, according to directions from task scheduler module 22. In the slave mode, pin sharing module 25 may mask a transmit enable signal TX#EN according to CS# for a given chip #.

Clock manager module 16 generates the various clock signals used by SSPI 10. A core clock (referred herein as clk_ref) and a clock signal for master state machine 23 are generated by clock manager module 16. the various clock signals may be a multiple or divided clock of the main or reference clock signal. Clock manager module 16 also is used to extract a clock from SCLK pin for slave state machine module 23 when in the slave mode.

FIFO manager module 12 stores data received from SOC interface module 13 into one of four logical TX FIFOs and provides data to sequencer module 21 for transmission as needed in parallel. FIFO manager 12 also stores data received from sequencer module 21 into one of the four logical RX FIFOs and have the data ready for reads to SOC interface module 13. FIFO manager module 12 also partitions two physical FIFOs, one for transmit and one for receive, into multiple logical FIFOs. In this example embodiment, four TX and four RX FIFOs are used. For that purpose, FIFO manager module 12 uses four sets of read and write pointers in order to make sure that data is read from and written to the correct FIFO. The actual number of physical and/or logical FIFOs may vary in other applications and embodiments.

SOC interface module 13 is a simple slave interface that is used for reading and writing registers from SOC bus 17. In one embodiment, SOC bus 17 is a 32-bit data bus with approximately 4 KB of address range. Other embodiments may use different numbers and/or schemes.

DMA request module 15 is a DMA controller that provides DMA requests to keep data movement at peak rate. In one embodiment, DMA control links SOC bus 17 to two RX FIFOs and two TX FIFO by use of four request lines. Interrupt generation module 14 operates as an interrupt controller to provide interrupt requests for SSPI 10.

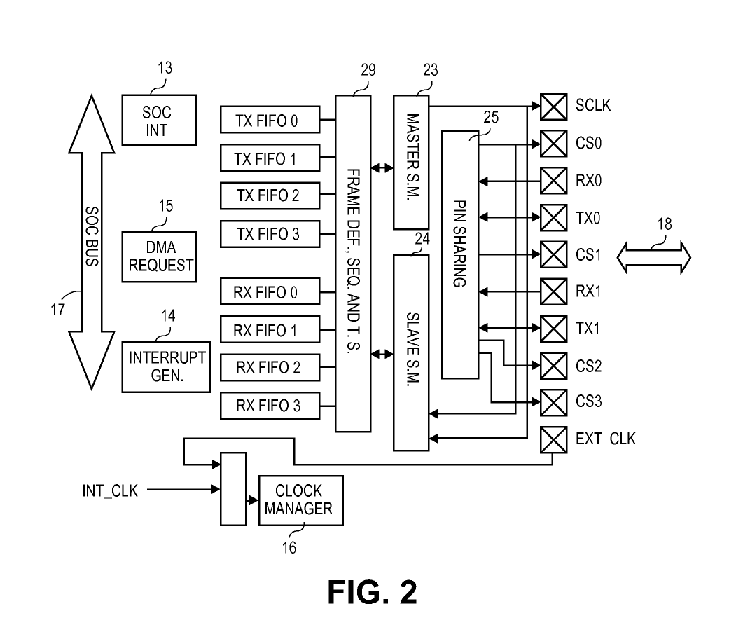

Because SSPI 10 is programmable, SSPI 10 may be configured to have one of a plurality of interface schemes. FIG. 2 illustrates a typical interface configuration for SSPI 10. In the example embodiment shown in FIG. 2, SSPI 10 is shown having a pair of transmit data lines TX0 and TX1, a pair of receive data lines RX0 and RX1 and four chip select lines CS0-CS3. These various lines are coupled externally to I/O connection 18 at corresponding chip pins noted in FIG. 2. Clock connection for the SCLK is made at SCLK pin. Furthermore, there is present an external clock connection at pin EXT_CLK. An external clock EXT_CLK may be used in some instances to provide a reference clock signal to clock manager module 16. As shown, SSPI 10 of FIG. 2 may be programmed to support a pair of TX and pair of RX lines to any of one, two, three or four external chips, components, or devices. Furthermore, although the external connection is referenced as I/O, it need not be limited to an I/O device. Various other devices may be coupled to SSPI 10.

As shown in FIG. 2, each of the TX FIFOs and each of the RX FIFOs is coupled to master state machine module 23 and slave state machine module 24. As to which FIFOs operate in TX mode, RX mode, or with which external device is strictly a design choice based on programmability. Modules 13, 14, 15 function to interface the FIFOs to SOC bus 17, as described above and clock manager module 16 provides various clock signal(s) used by SSPI 10. Clock manager module 16 obtains a reference clock either from an internal (internal to the chip) clock source INT_CLK or an external clock source EXT_CLK. It is appreciated that FIG. 2 is just one example of how SSPI 10 may be configured. In other embodiments, there may be different number of TX lines, RX lines, CS lines, clock lines and/or different number of TX and RX FIFOs. Block 29 is shown in FIG. 2 to combine the operations performed by frame definition module 20, sequencer module 21 and task scheduler 22, which operations are described in detail below.

Some of the features supported by SSPI 10 may include, but are not limited to, such features as:

1) programmable to operate with up to 4 master ports or with 1 or more slave port(s), for a standard protocol or in multi-channel mode;
2) physical RX and TX FIFOs of approximately 2 KB are used in one embodiment and approximately 128 Bytes in another;
3) programmable DMA and interrupts;
4) support for up 32-bit data transfer per frame of data;
5) dynamic clock gating for low-power;
6) support for up to approximately 52 MHz line operation in master mode, and approximately 26 MHz in slave mode;
7) capable of operating from an external reference clock;
8) highly programmable core through instruction program for different devices and tasks;
9) protocols supported, include (but are not limited to): Synchronous Serial Frame Protocol, Serial Peripheral Interface (SPI), Microwire, Point to point I2C master, multi-channel protocol with no limit on slot numbers, I²S, as well as protocols related to audio formats, CODEC's, DACs and SPDIF; and
10) operations that include (but are not limited to): having four chip-selects in master mode to allow for 4 logical ports, programmable and sharable FIFO per port up to approximately 2 KB for each direction, combined receive and transmit operations, receive-without-transmit operation, transmit-without-receive operation, use of external clock, ability to interface to a variety of Code/Decoders (CODECs) and digital-to-analog converters (DACs), ability to pack and unpack data to reduce host processor load, and ability to be accessed simultaneously by multiple processors.

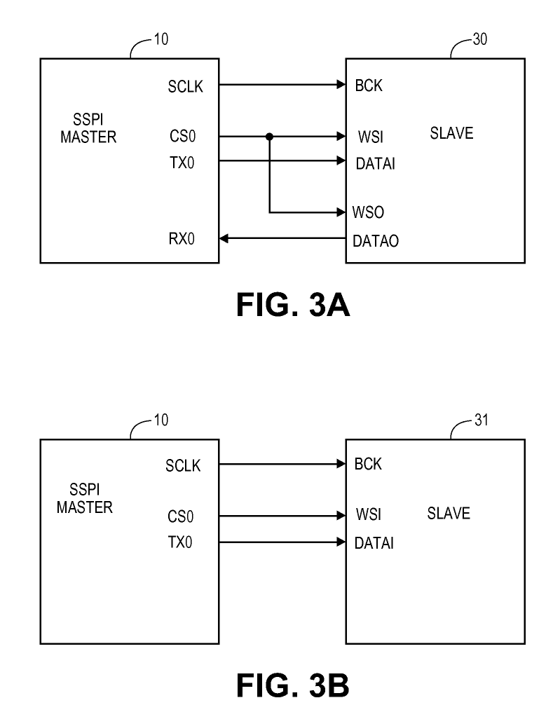

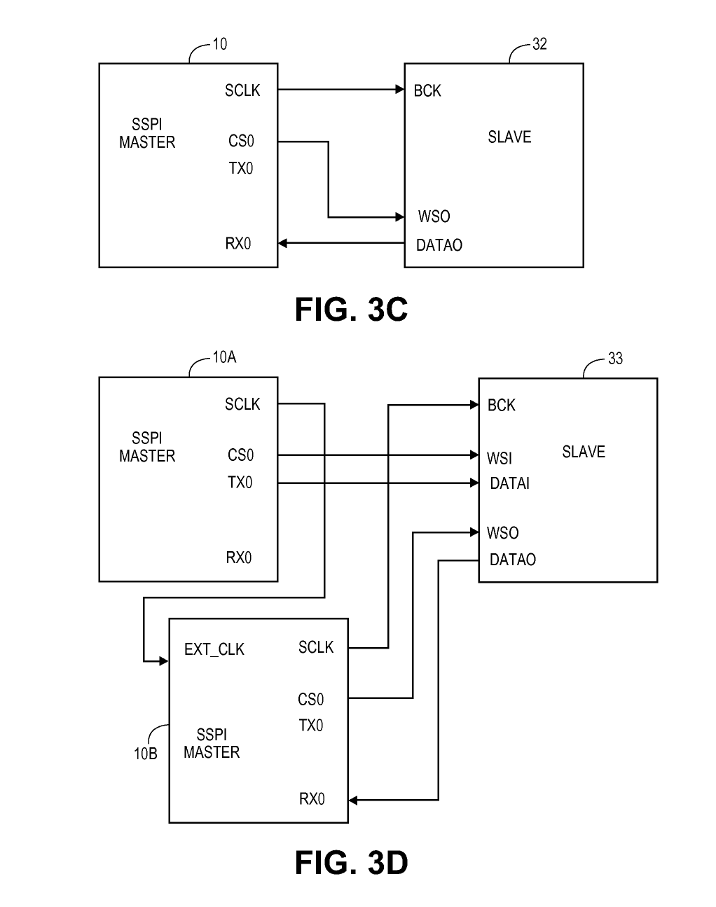

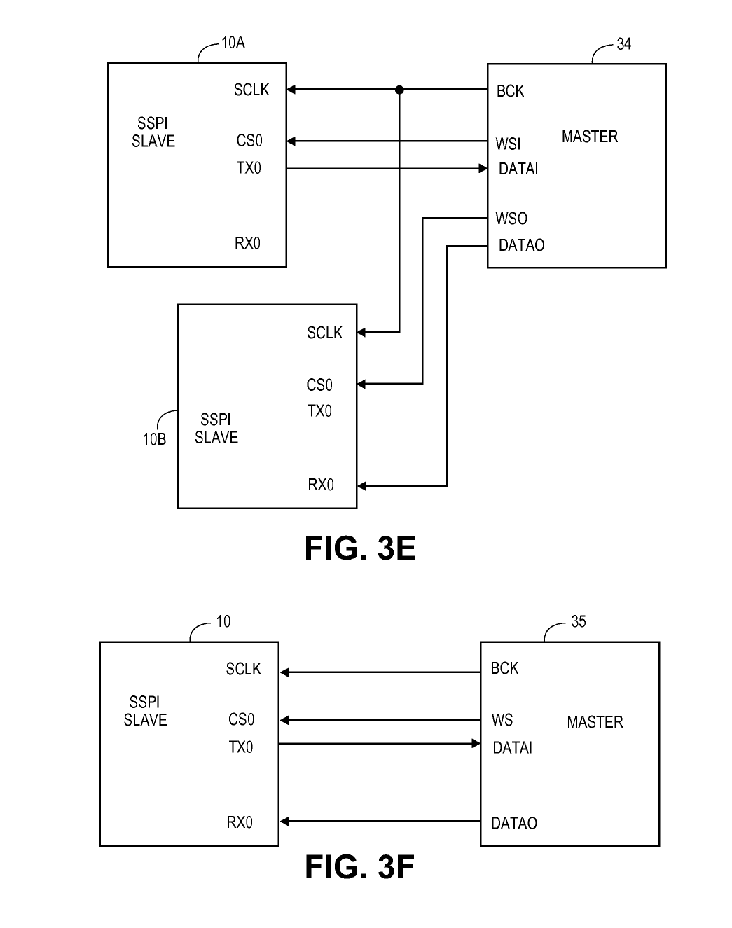

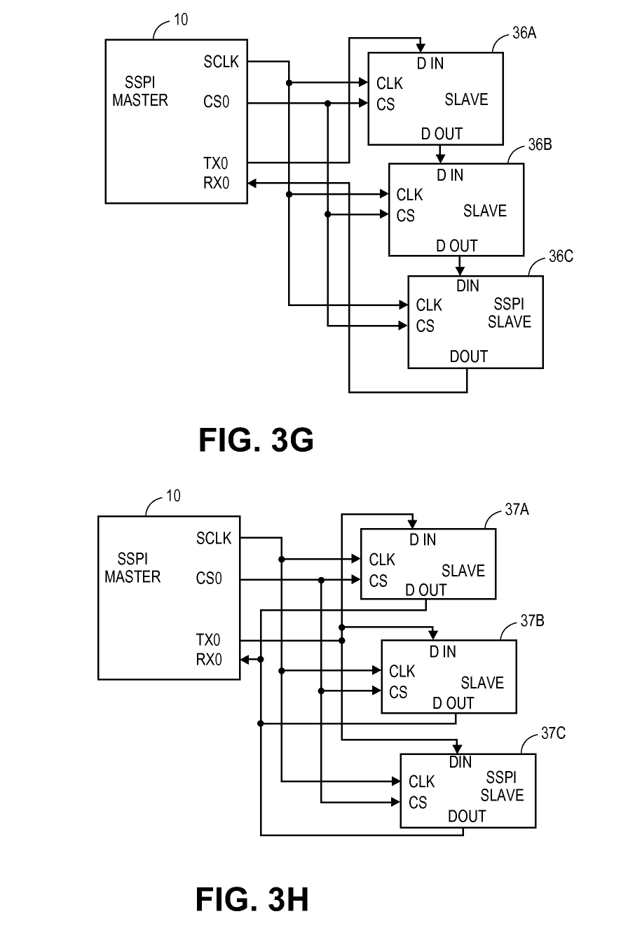

It is to be noted that because SSPI 10 is programmable, this flexibility allows SSPI 10 to be configured to provide a variety of interface options in synchronously transferring data. SSPI 10 may be set as a master or a slave unit for data transfer. A few such examples are noted in FIGS. 3A-3H. In FIG. 3A, SSPI 10 is used as a master and couples to an external slave 30 with a share Left_Right (LRC) signal. FIG. 3B shows SSPI 10 used as a master that couples to an external slave 31 with a TX channel only. FIG. 3C shows SSPI 10 used as a master that couples to an external slave 32 with RX reception only. FIG. 3D shows a use of two SSPI units 10A, 10B coupled to an external slave 33 with TX and RX lines using their own LRC signal. FIG. 3E shows a use of two SSPI units 10A, 10B as slaves that couple to an external master 34 with TX and RX lines using their own LRC signal. FIG. 3F shows SSPI 10 as a slave with a connection to an external master with TX and RX sharing the LRC signal. FIG. 3G shows SSPI 10 as a master to provide a loop connection to three slaves 36A, 36B, 36C. FIG. 3H shows SSPI 10 as a master to provide a tree connection to three slaves 37A, 37B, 37C, of which slave 37C is shown as a second SSPI device. These example connections of SSPI 10, as a master or a slave unit, are just few of many techniques available to configure SSPI 10 for data transfer. Other configurations for SSPI 10 may be used in other embodiments for practicing the invention.

### Frame Definition Module

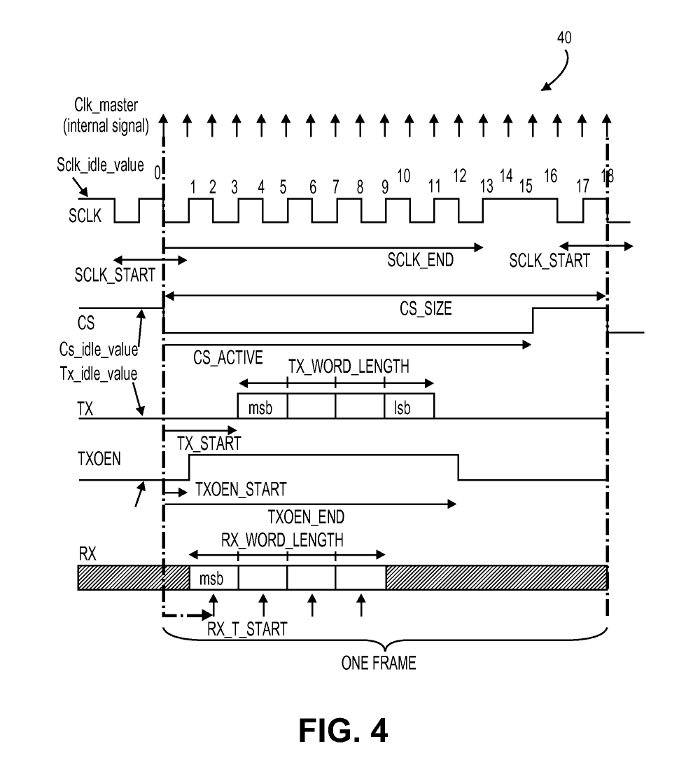

An operation of frame definition module 20 is described below, first in master mode and subsequently in slave mode. One main function of frame definition module 20 is its ability to allow for programming of different serial synchronous protocols that currently exist or will exist in the future. The protocols vary on when data is driven with respect to a chip select (CS) signal or when clock is driven and, therefore, requires a highly programmable solution. A basic unit of block transfer is referred to as a frame and the frame is programmable to define the various timing parameters that are made available. Depending on the external device and the protocol required for the communication, a single frame may be used to transfer data or multiple frames may be used to transfer block(s) of data. An example timing diagram 40 for one frame for master mode is illustrated in FIG. 4, including various parameters that may be programmed. Timing diagram 40 shows parameters for determining timing of signals on the SCLK, TX, RX and CS lines between SSPI 10 configured as a master and an external slave chip(s). As noted, the timing is referenced to an internal clock signal, noted as Clk_master. A transmit enable TXOEN parameter is used as well to initiate and end an output period. All timing relationships shown in FIG. 4 are with respect to the activation of the CS signal.

Furthermore, an alternative parameter that may be used is clock ratio. In the event an 1:2 clock ratio is used, an edge of SCLK clock may be generated at every rising edge of clk_master. For an 1:8 ratio, an edge of SCLK clock may be generated at every four rising edges of clk_master. Other ratios may be used as well.

In reference to the timing diagram of FIG. 4, a description of the various parameters is shown in the following Table 1. Each of the parameters may be programmed so that SSPI 10 may accommodate different protocols, standards, and other communication formats.

TABLE 1
SSPI Frame Definition in Master Mode

| Parameter | Description |
|---|---|
| SCLK_START | This parameter is the number of clk_master periods relative to the activation of CS. |
| | A negative number means the clock is starting prior to CS and a positive number, |
| | defines SCLK post CS. |
| SCLK_END | This parameter indicates the number of clk_master clock periods until the first |
| | missing edge of SCLK. |
| CS_SIZE | This parameter is the size of the frame in term of number of periods of clk_master |
| | clock. The frame is defined as the time between the beginning of 2 consecutive |
| | active CS. |
| CS_ACTIVE | This parameter is the number of clk_master clock periods that CS is active. |
| TX_START | This is the number of periods of clk_master clock before the 1^{st} bit of data is driven |
| | (launched). Each bit is driven for one SCLK period. The # of bits that are driven is |
| | equal to Word Length defined in a TX configuration register. |
| TXOEN_START | This parameter is the number of clk_master clock periods before the output enable |
| | is asserted. |
| TXOEN_END | This parameter is the number of clk_master clock periods before the output enable |
| | is de-asserted. |
| RX_START | This parameter is the number of clk_master clock periods when the 1^{st} bit is |
| | captured. The RX line is sampled every SCLK period thereafter. The # of bits |
| | captured is equal to the Word Length defined in a RX configuration register. |

In addition to the timing relationship, the idle state of SCLK, CS, TX may be programmed through the use of registers. As such, the active state is defined as an inversion of the idle state. Likewise, whether to extend the MSB and LSB in the transmit data may be programmed as well. As noted in Table 1, TX and RX configuration registers may be used to set the word length for transmit and receive data, respectively.

The various parameters setting may be configured such that, in some instances, the frames overlap each other. This overlap is possible since the parameters defined after CS_SIZE are used through the next frame.

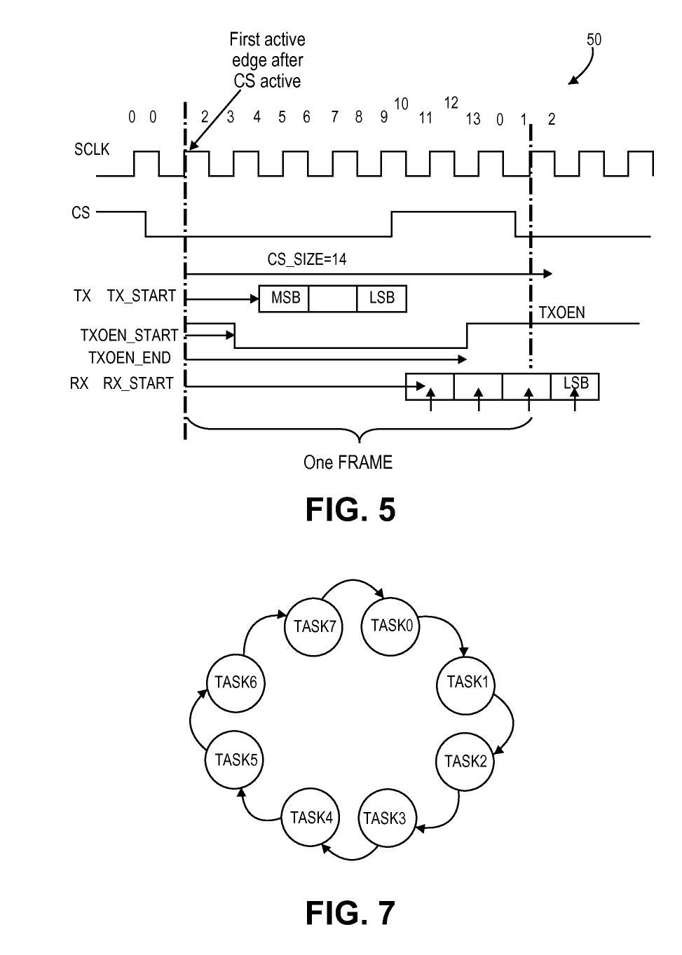

As with the master mode, frame definition may be programmed for the slave mode. An example timing diagram 50 for one frame for slave mode is illustrated in FIG. 5. A primary difference between the frame definition in the master mode and the slave mode is that, instead of referring to clk_master edges, timing is based on the edges of incoming SCLK. This is due to the fact that in the slave mode, the host is not in charge of the clock and the chip select line.

Timing diagram 50 shows signal timing between SSPI 10 configured as a slave to operate with an external device that is the master. The timing relationships shown in FIG. 5 are with respect to a first reference edge clock after activation of chip-select, at time reference 1. Time 0 refers to everything that happens prior to that event. The definition of which reference edge (either positive or negative) to use, may be programmed as well. When programming registers, each edge refers to a count value.

In reference to the timing diagram 50 for frame definition in the slave mode, the following Table 2 defines the various parameters.

TABLE 2
SSPI Frame Definition in Slave Mode

| Parameter | Description |
|---|---|
| CS_SIZE | This parameter is the size of the frame in terms of edges. |
| TX_START | This parameter is the # of edges where the 1^{st} bit of data is driven (launched). A bit |
| | is driven for exactly 2 edges (1-cycle). The # of bits driven is equal to a Word |
| | Length defined in the TX configuration register. |
| TXOEN_START | This parameter is the # of edges in which the output enable is asserted. |
| TXOEN_END | This parameter is the # of edges in which the output enable is de-asserted. |
| RX_START | This parameter is the # of edges when the 1^{st} bit is captured. Following bit captures |
| | take place every other clock edge. The # of bits that are captured is equal to the |
| | Word Length defined in a RX configuration register |

Accordingly, by selecting appropriate parameter values, a frame definition may be created for a frame in the master mode and/or slave mode, depending on the particular frame format(s) that are needed. Furthermore, although SSPI 10 may operate with one frame definition, typically, a plurality of frame definitions are created. In one embodiment, a frame table is used to store the various frame definitions. The plurality of frame definitions allow flexibility to have SSPI 10 communicate with a number of external devices, wherein some of those external devices may operate using different communication protocols that require different frame definitions. Some protocols may require multiple frames that are not all the same in way of frame definitions. Although any size frame definition table may be used, in one embodiment, the frame definition table stores 8 frame definition entries that are shared for master mode and slave mode operations. These entries are then referenced by a program in sequencer module 21 and used by master state machine 23 and/or slave state machine 24. In another embodiment, the frame definition table is reduced to two frame definitions.

### Sequencer Module

Although some protocols may require only one frame definition, or multiple frames by repeating the same one frame, other protocols may require multiple frames where a subsequent frame is different from a previous frame. In order to accommodate multiple frame definitions, sequencer module 21 executes instructions that specify and select particular frame definitions stored in the frame definition table. As part of each instruction, an instruction field contains a pointer to one frame in the frame table which provides the timing details of the frame that is to be executed. In addition, each instruction also contains an opcode (OPC) which determines which instruction to execute next. There may be additional parts to an instruction as well. Therefore, by use of multiple instructions in sequencer module 21, multiple frames may be concatenated to create a jumbo frame.

An example programming is shown in Table 3 below that illustrates how five instructions (#0-#4) are combined to produce a definition for a jumbo frame. Table 3 is just one example and other embodiments may be implemented as well.

TABLE 3

| Instruc- | | Next_{—} | Repeat_{—} | Frame_{—} | Clk_{—} | CS_{—} | CS_{—} | Transmit_{—} | FIFOTX_{—} | TXOEN_{—} | Receive_{—} | FIFORX_{—} |
|---|---|---|---|---|---|---|---|---|---|---|---|---|
| tion# | OPC | PC | count | def_sel | idle | activate | deactivate | on | sel | active | on | set |
| 0 | next | | 0 | 0 | no | yes | yes | yes | 1 | yes | yes | 3 |
| 1 | next | | 0 | 0 | no | no | no | no | | yes | no | |
| 2 | next | | 0 | 0 | no | no | no | no | | yes | yes | 2 |
| 3 | Cond. | 0 | 0 | 0 | no | no | no | no | | yes | no | |
| | jump | | | | | | | | | | | |
| 4 | stop | | 0 | 0 | yes | no | no | no | | no | no | |

### Instruction Field Details:

Frame_definition sel: a sequence is always applied on top of a frame definition. If a transmission needs to happen, it will start at TX_START, otherwise default value is transmitted. Transmit/Receive: means data are read or written in the selected FIFOs. Otherwise, there may be a transmission of default value or data coming from elsewhere. TXOEN is controlled independently.
Repeat_count: in order to concatenate code, this indicates how many times to repeat that instruction before executing the next one (0: do once, 1: do twice, . . . ).
OPC field: indicates what the next instruction should be:

OPC=next,

OPC=stop. This is the only way to exit cleanly. After executing repeat_count times that instruction, it gives control back to task_scheduler.

OPC=Conditional Jump. After executing repeat_count times that instruction, if loop_register>0, jump to the instruction indicated in next_PC field, then decrement loop_register, otherwise execute next instruction. This also happens if some “stop condition” has appeared during execution of that loop.

OPC=Alternative Jump. Jump to next_PC field directly without executing instruction, reload loop_register to initial value, and generate an interrupt, as long as do_once in the task description is not set, otherwise execute next instruction.

A sequence includes a stop, in order to conclude a task and accede to the task manager.
The Loop register initial value is part of the task scheduler.
An unexpected stop condition results from any of the following:

Task scheduler disabled,

Current task disabled,

Underrun or Overrun if StopOnFIFOerror is set for that task.

Table 4 provides a description of the main field of the sequencer instruction in master mode. Again, this is just one example for practicing the invention.

TABLE 4
SSPI Instruction Field

| Field Name | Size | Description |
|---|---|---|
| opcode | 2-bits | This is the opcode. The following is the encoding: |
| | | 00: next =>next PC is at PC + 1. |
| | | 01: conditional jump, |
| | | 01: alternative jump, |
| | | 11: stop. Stop execution of the sequencer. |
| next_pc | 5-bits | Pointer to next sequencer instruction when opcode is conditional or |
| | | unconditional jump. |
| repeat_count | 8-bits | Instruction execution is repeated based on value of this count, before |
| | | updating PC (0: do once, 1: do twice, . . . ). |
| clk_idle | 1-bit | When set to 1, Clock will not output during that frame. |
| | | It is meant to be used for long dead cycles between accesses. |
| cs_activate | 1-bit | When this bit is 1, chip-select is activated during the frame |
| cs_deactivate | 1-bit | When this bit is 1, chip-select is deactivated during the frame (at cs_activate |
| | | count) otherwise chip-select is left unchanged. |
| transmit | 1-bit | When this bit is 0, data is not read from the FIFO. This allows for |
| | | transmission of default value |
| receive | 1-bit | When this bit is 0, no data is captured and written into FIFO. |
| tx_oen | 1-bit | When this bit is 0, output enable is not asserted and TX data is left floating. |
| RX FIFO# | 2-bit | This is the pointer to FIFO to which incoming data is written to. |
| TX FIFO# | 2-bit | This is the pointer to the FIFO from which outgoing data is read from. |
| Frame | 3-bit | This is the pointer to frame table that contains the definition of the frame. |
| Definition# | | |
| Pattern_mode | 1-bit | Master only. |
| | | Instead of transmitting according to a frame description, one of the 4 patterns |
| | | is selected for transmission according to the 2 lsb bits of Frame_definition. |
| | | It gives ability to match special behavior such as a start and stop condition. |
| | | There is no transmission or reception to/from the FIFO during execution of |
| | | that instruction, but SCLK, CS, TX and TXOEN are driven as described in the |
| | | pattern. |

The instructions in sequencer module 21 are then used to establish the format of each frame or jumbo frame by selecting appropriate frame definition(s) from the frame definition table in frame definition module 20. In one embodiment a sequencer table is used to store a sequence or succession of program instructions. In one embodiment, the size of the sequencer table is 32 instructions. In other embodiments, there may be more or less instructions. Sufficient memory is allocated to store multiple programs required to perform multiple transactions or tasks. In one embodiment where 32 instructions are stored, the table is visible to software as thirty-two 32-bit registers mapped into a memory space.

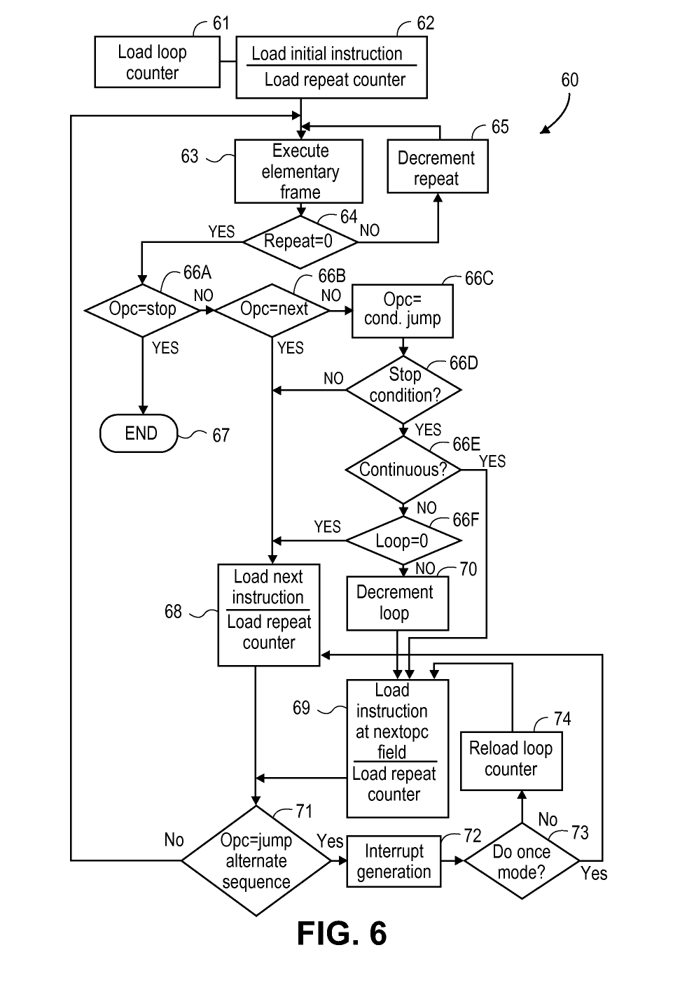

The beginning of the 1st instruction to execute is defined as part of task scheduler and is described further below. An example operation of sequencer module 21 in executing the instructions is shown in flow chart 60 of FIG. 6.

In flow chart 60, a loop counter is first loaded (block 61), along with loading a repeat counter and an initial instruction of a set of sequencer instructions (block 62). Then the instruction is executed to obtain the elementary frame from the frame definitions (block 63). If the repeat counter is not 0 (decision block 64), the repeat counter is decremented (block 65) and elementary frame is executed again (block 63). If the repeat counter is 0 at decision block 64, OPC determines which of the decision paths (blocks 66A-66F) is to be taken, whether to end the program (block 67), load the next instruction and repeat counter (block 68) or load the instruction specified by the next OPC field along with the corresponding repeat counter (block 69). In the conditional jump case, the loop counter is checked (block 66F) and decremented (block 70), if not 0. If after loading the next instruction of the sequence (block 68) or the instruction specified by the next OPC field, if the OPC does not dictate a jump to an alternate sequence (block 71), the process is repeated again at block 63. Otherwise, an interrupt is generated (block 72) followed by a return to the process of block 68 or block 69, depending on a do-once-mode decision (decision block 73), which may require reloading of the loop counter (block 74).

### Task Scheduler Module

As described above, a frame definition provides for cycle-by-cycle behavior when signals toggle within a frame between a master and a device. In addition, an instruction sequencer is described which allows for execution of multiple instructions to form a larger unit (e.g. jumbo frame) for transferring data. This larger unit of transfer is referred to as a task. One example of a task is to perform a bulk read from an external storage device or to perform a bulk write to the same external storage device, such as flash memory. Both tasks talk to the same external device, but frame by frame behavior is different when data is captured into the FIFO versus sending from the FIFO. Thus, two different programs may be required, one to write the data and one to read data. Another example of a task is performing time-division multiplexing (TDM) transfers to and from an external CODEC. Other examples for performing data transfer tasks abound and only a few examples are noted herein.

SSPI 10 allows for multiple tasks to be defined and scheduled. In one embodiment for SSPI 10, eight separate tasks are defined and maintained in task scheduler module 22. The number of such tasks to be defined may be less or may be more in other embodiments for SSPI 10. These defined tasks are available and shared among all of the chip-selects. Although the same task may be applied to one, some or all of the coupled CSs, SSPI 10 also allows for different tasks to be assigned to each of the CSs. For some embodiments when only one CS is used, the total number of tasks may be reduced to a much lower value, such as two.

FIG. 7 illustrates an operation of task scheduler module 22. In one embodiment, the task scheduler simply cycles through each of the eight tasks, shown as Task 0-Task 7, in a round-robin manner. When one task is done, the schedule moves to the next task in the loop. As part of a task field register, there is a bit that defines whether to turn ON or OFF a task. If a task is turned ON, then it is executed. The set of instructions in the sequencer pointed by the task are executed. If a task is turned off, the corresponding set of instructions are not executed. Thus, although a defined number of tasks are looped through for a given CS line, only those tasks that are turned on are executed. Switching between tasks is a multi-cycle operation as clocks are switched off and on, and as such there are multiple idle cycles on the line. In the instance SSPI 10 is to operate as a slave, only one task may be scheduled to be on.

Another example usage of task scheduler module 22 is when multiple CSs are utilized in which the CS lines are coupled to different external devices. In this instance, multiple tasks may be allocated to each device depending on the protocol (e.g. flash device, SPI, and SSP) being implemented. Each external device may operate using different protocols, since the task scheduler may be programmed for each CS line.

In one embodiment, a task is defined by associating certain properties, such as connected resources, where to start the execution of the sequence instructions and identifying a start_condition and/or a stop_condition. Example fields that define a task may include Task_enable and Execute_once_only. Starting task conditions may specify an Initial Condition (which is linked to how each FIFO is empty or full), a Skip (e.g. to “skip” if Initial Condition is not met), and/or WaitBeforeStart (WBS) (e.g. wait until Initial Condition is met before starting. Task end conditions may specify a Continuous condition (e.g. when set to 1, sequence of instructions delimited by opc=conditional_jump is repeated indefinitely, until any kind of stop condition (such as task disabled) is met), a Loop condition (e.g. repeat the sequence loop that many times [0: do once, 1: do twice, and so on], and Stop_on_FIFO condition (e.g. stop when FIFOs used in sequence become full/empty).

Other items which may be included in task scheduling may include information about interrupt generation and disabling of the task scheduler, such as task_done_int (e.g. when set, the task_scheduler generates an interrupt at the end of that task execution) and task_stop_scheduler (e.g. when set, the task_scheduler will disable itself at the end of that task). Other task information may include information for the sequencer, such as LSBfirst (data are received/sent LSB or MSB first), Pointer_to_first_sequence (to point to the first instruction), and FIFO_error_behavior (to stop the clock or to repeat the transmission), and information for pin sharing module 25 and clock manager module 16.

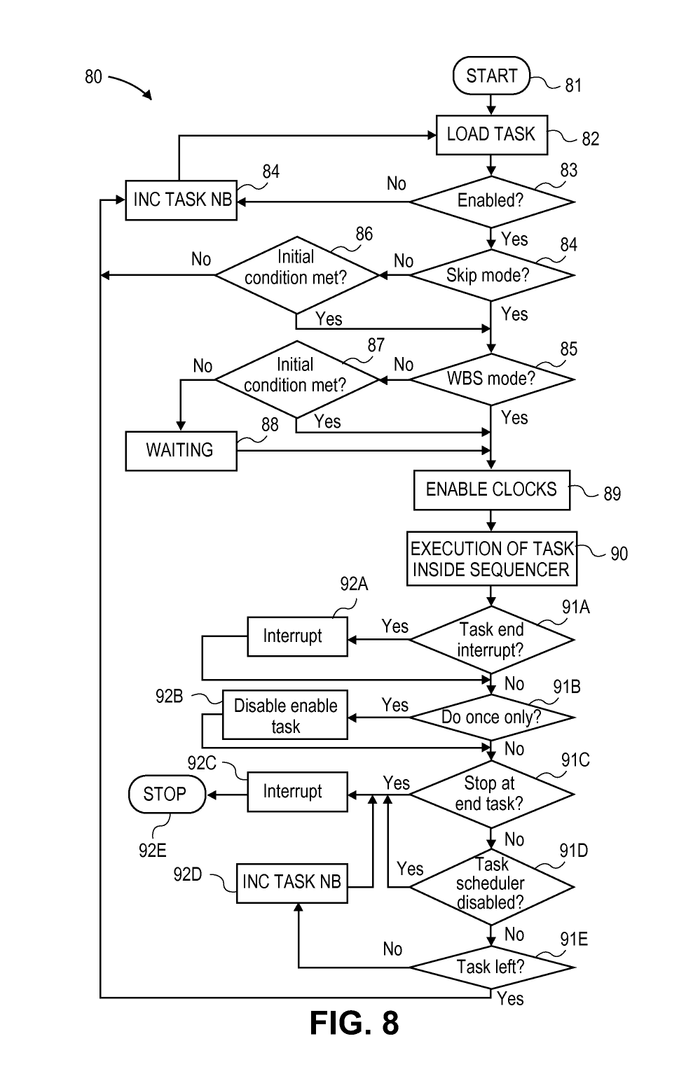

An example operation of task scheduler module 22 in performing a task is shown in flow chart 80 of FIG. 8. When starting task scheduler module 22 (block 81), the initial task (Task 0) is loaded (block 82). The loaded task is checked (decision block 83) to determine if it is one of the task(s) enabled for the particular device, protocol, etc. If the task is not enabled, the task is ignored and the task number is incremented (block 84) to load the next task (block 82) in the order of tasks. If the task is enabled, then initial conditions for “skip mode” and/or WBS mode are determined (decision block 84 and 85) and, if needed, the initial condition requirements are checked to see if they are met (decision blocks 86, 87). A wait time may be inserted, if initial conditions are not met for WBS (block 88).

Next, the clocks are enabled (block 89) and the sequence of instructions in sequencer module 21 that correspond to the particular task are executed (block 90). After the instructions are executed, other task conditions may be checked (decision blocks 91A-91E) with accompanying actions (blocks 92A-92E) and if no further actions are required by the particular task, the routine transitions to the next task in the order of tasks (block 84). The next task is loaded and the routine repeated for the new task. As noted above, each of the external devices having a CS line from SSPI 10 may have a particular task or set of tasks assigned in task scheduler 22.

### Operation of the Frame Definition, Sequencer and Task Scheduler Modules

The following description provides how frame definition module 20, sequencer module 21 and task scheduler module 22 may be programmed to provide the various frame(s) for data transfer to be effected. Prior to using SSPI 10, SSPI 10 is configured to be in a master or slave mode. Generally, this is done prior to operation of SSPI 10, since alternating master/slave modes between tasks is not desirable or not permitted. All resources, such as FIFOs, tasks, sequencer table, frame definition table, and DMA are set for sharing. A task is typically defined by a specific frequency, unique CS, unique RX, and/or unique TX. A sequence is typically defined by a succession of individual frames with no lost cycles, an association of TX FIFO to a TX choice, and/or an association of RX FIFO to a RX choice.

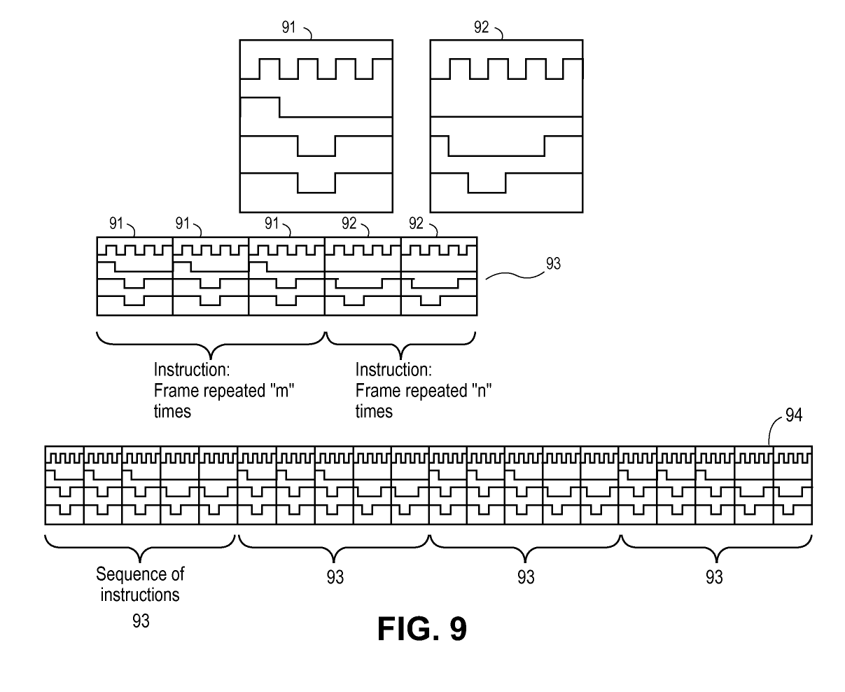

Once the tasks are set, frame definitions are created and stored in the frame definition table. The afore-mentioned parameters of Table 1 may be used to establish various frame definitions. FIG. 9 shows two example frame definitions 91, 92. Once the necessary frame definitions are created and stored in the frame definition table, a sequence of instructions are written to select the frame definitions and stored in the sequence table. In FIG. 9, an example is shown in which a sequence of instructions is to select five frames as a sequence 93. Although five instructions may be used to select the five frames as sequence 93, since the first three frames use frame definition 91 and the last two use frame definition 92, in one embodiment, a parameter in the instruction causes a frame definition to be repeated. In sequence 93, an instruction selects frame definition 91 as the first frame and repeats this frame 91 two more times. A second instruction selects frame definition 92 as the second frame type (fourth frame in sequence 93) and repeats this frame 92 one more time.

Thus, a succession of instructions that puts a number of frame definitions into a sequence is generated and stored as a sequence of instructions in sequencer module 21. A particular task may then call the stored sequence of instructions as its task. When called, the sequence may be looped a given number of times for a task, similar to the repeat of the frame definition in creating sequence 93. Thus, sequence 93 instructions may be looped three more times to provide a task 94 that comprises four iterations of sequence 93. The described task of FIG. 9 may be written in software as:

SEQUENCE

| | | |
|---|---|---|
| 6 | OPC=next | Repeat=2(3−1) FRAMEblue |

| | | | | |
|---|---|---|---|---|
| 7 | OPC=cond.Jump | PCnext=0 | Repeat=1 | FRAMEgreen |

| | | | |
|---|---|---|---|
| 8 | OPC=Stop | Repeat=0 | FRAMElast(clock off-TXoff- CSoff usually) |

TASK

| | | | |
|---|---|---|---|
| 0 | InitialSequence=6 | loop=3(4−1) | ... |

[where colors are used to distinguish different frames in this example]

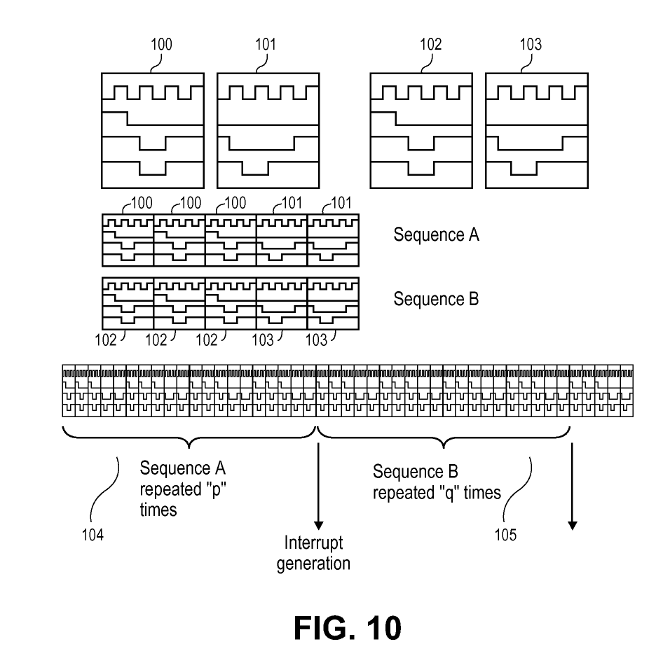

Likewise, an illustration of an alternate jump is illustrated to show a task in FIG. 10. FIG. 10 shows four frame definitions 100, 101, 102, 103 (which are also coded as blue, green, purple and grey). Sequence A is created by three iterations of frame definition 100 followed by two iterations of frame definition 101. Sequence B is created by three iterations of frame definition 102 followed by two iterations of frame definition 103. Subsequently, four iterations of sequence A are used for task 104 and four iterations of sequence B is used for task 105. the two sequences are concatenated to form a jumbo frame sequence, which may be looped a number of times. In this particular example, task 104 is associated with a pair of FIFOs, while task 105 is associated with a different pair of FIFOs. Tasks 104 and 105 may be applicable to different external devices controlled by different CS lines. An interrupt is generated after sequence 104, in order to signify a task boundary.

The described task of FIG. 10 may be written in software as:

Double SEQUENCE

| 6 | OPC=next | Repeat=2 | FRAMEblue | |
|---|---|---|---|---|
| 7 | OPC=cond.Jump | PCnext=0 | Repeat=1 | FRAMEgreen |

| 8 | OPC=Alternate JUMP | | PCnext=10 |
|---|---|---|---|
| 9 | OPC=Stop | Repeat=0 | FRAMElast(clock off-TXoff- CSoff usually) |
| 10 | OPC=next | Repeat=2 | FRAMEpurple |

| | | | | |
|---|---|---|---|---|
| 11 | OPC=cond.Jump | PCnext=10 | Repeat=1 | FRAMEgrey |

| 12 | OPC=AlternateJUMP | | PCnext=6 |
|---|---|---|---|
| 13 | OPC=Stop | Repeat=0 | FRAMElast(clock off-TXoff- CSoff usually) |

TASK

| | | | |
|---|---|---|---|
| 0 | InitialSequence=6 | loop=3 | ... |

Lines 9 and 13 are used, in case a stop condition occurred, respectively during sequence A or during sequence B. With the Alternate Jump instruction, no frames are executed and an interrupt may be generated. If “Do once only” field is set, the instruction is ignored, and proceeds directly to the next instruction. Otherwise, a jump is made. The “Do once only” field is updated every time the Alternate Jump sequence is reached. The Alternate Jump allows transmitting/storing data in the FIFOs while PCLK is off, waking up periodically to empty/store needed data in the FIFO.

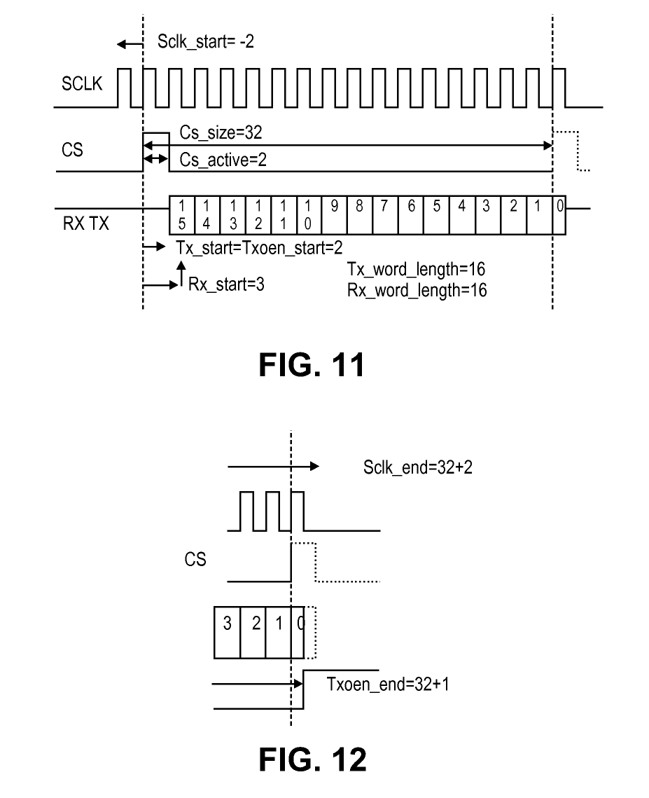

In defining a frame, FIG. 11 shows an example of a sequence in the master mode. The first frame is looked at to define the starting values. Since SCLK needs to start prior to CS being activated, sclk_start is shown as a negative number. Likewise, as shown in FIG. 12, the last frame is looked at to define the ending values. SCLK_END indicates the first missing edge. If SCLK_START is equal to or more than SCLK_END, no clock is generated.

For slave mode, a main difference is to define FIRST_ACTIVE_EDGE as positive edge. CS_SIZE, TX_START, RX_START, TXOEN_START, TXOEN_END, TX_WORD_LENTH, RX_WORD_LENTGH, CS_IDLE_VALUE, TX_IDLE_VALUE remain the same. CS_ACTIVE would be redefined to 0 and CLK_START, CLK_END are not used. With most protocols, the main difference is that in the master mode the TX line is driven all the time and in the slave mode, it is to be at high-impedance (high-Z) state as soon as CS is deselected. A mode defined in the task description, can enable the masking of TXOEN generated by the slave state machine when CS is not selected.

In some embodiments of SSPI 10, a pattern mode may be used with the instructions. When an instruction sets a pattern mode, instead of the programmed frame definition, a predefined pattern may be selected for execution. Frame definition usage and pattern usage may be alternating. Pattern mode is typically used in a master mode. In pattern mode, a control register may be used to define a length of the pattern, and registers that match the behavior of SCLK, CS, TX, and TXOEN (starting from LSB to length) may be used as well.

### Clock Scheme

Although various clock schemes may be used, in one embodiment for SSPI 10, three clocks are used for SCLK generation. An internal clock INT_CLK from a phase-locked-loop (PLL), external clock EXT_CLK from a chip pin and an audio clock from a audio PLL. This audio clock comes from an audio PLL inside the chip and used for network mode operation when high-precision audio clock is required for communication with an external CODEC. A multiplexer (MUX) is used to select from the three clock signals. From there a number of clock signals are generated by clock manager module 16. The clock signal may be changed for each task. Other clocks may be used as well.

Thus, a synchronous serial programmable interface is described. It is to be noted that various protocols may be programmed for use with the SSPI device of the present invention to perform the data transfer. These protocols include, but are not limited to, SSP synchronous serial frame format, SPI, Microwire, 12C, 12S, audio protocols, telephone CODEC protocols, SPDIF format for data output, flash memory protocols, etc. These are just few of the protocols that may be utilized through programmability of the SSPI device of the present invention. Furthermore, it is to be noted that although the above description describes one or more particular interface(s), the interface is applicable to arbitrary serial formats. The interface may also be applicable to other tasks, such as PWM and PDM when used with appropriate data stream. The invention is not limited only to the above-described embodiments.

As may be used herein, the terms “substantially” and “approximately” provides an industry-accepted tolerance for its corresponding term and/or relativity between items. Such an industry-accepted tolerance ranges from less than one percent to fifty percent. Such relativity between items ranges from a difference of a few percent to magnitude differences. As may also be used herein, the term(s) “coupled” and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level.

The embodiments of the present invention have been described above with the aid of functional building blocks illustrating the performance of certain functions. The boundaries of these functional building blocks have been arbitrarily defined for convenience of description. Alternate boundaries could be defined as long as the certain functions are appropriately performed. One of ordinary skill in the art may also recognize that the functional building blocks, and other illustrative blocks, modules and components herein, may be implemented as illustrated or by discrete components, application specific integrated circuits, processors executing appropriate software and the like or any combination thereof.

We claim:

1. An apparatus comprising:
a frame definition module to programmably define a plurality of frame definitions in which each frame definition provides signal timing for a corresponding frame used in transferring data;
a sequencer module coupled to the frame definition module to provide a plurality of instructions, in which each instruction, when executed, obtains a frame definition from the plurality of frame definitions; and
a task scheduler coupled to the sequencer module to define a plurality of tasks that are used in transferring data and when a particular task is scheduled for execution, the particular task is to select at least one instruction from the plurality of instructions and use the at least one instruction to obtain one or more frame definitions to establish one or more frames that are used in transferring data in executing the particular task.

2. The apparatus of claim 1, further including an instruction in the plurality of instructions that obtains a frame definition and repeats the obtained frame definition a number of times as specified in the instruction to generate multiple frames, all multiple frames having a same frame definition.

3. The apparatus of claim 1, wherein the particular task includes a sequence of instructions that are used to obtain a sequence of frame definitions to establish a sequence of frames for use in transferring data.

4. The apparatus of claim 3, wherein the particular task repeats the sequence of instructions a number of times as specified in the particular task to generate multiple sequence of frames from the repeated sequence of instructions.

5. The apparatus of claim 1, wherein the programmably defined frame definitions are used to support a plurality of data transfer protocols.

6. The apparatus of claim 1, wherein the programmably defined frame definitions are used in establishing frames that serially transfer data between a master device and a slave device.

7. The apparatus of claim 6, further including a plurality of storage devices for storage of data that are to be transmitted and data that are received, and wherein the particular task also defines which storage devices are to be used with the particular task.

8. The apparatus of 1, wherein the particular task has a sequence of instructions that concatenate multiple frame definitions to establish a jumbo frame of multiple frame definitions to transfer data.

9. An apparatus comprising:
a frame definition module to programmably set parameters that define and create a frame definition, create a plurality of frame definitions and store the frame definitions in a frame definition table, wherein each frame definition provides signal timing for a corresponding frame used in synchronously transferring serial data in an interface;
a sequencer module coupled to the frame definition module to provide a plurality of instructions that are stored in an instruction table, in which each instruction, when executed, obtains a frame definition from the frame definition table; and
a task scheduler coupled to the sequencer module to define a plurality of tasks that are used to serially transfer data and when a particular task is scheduled for execution, the particular task is to select at least one instruction from the instruction table and use the at least one instruction to obtain one or more frame definitions to establish one or more frames that are used to transfer data in executing the particular task.

10. The apparatus of claim 9, wherein the particular task has a sequence of instructions that concatenate multiple frame definitions to establish a jumbo frame of multiple frame definitions to transfer data.

11. The apparatus of claim 10, wherein the programmably defined frame definitions are used to support a plurality of data transfer protocols.

12. The apparatus of claim 11, wherein the programmably defined frame definitions are used in establishing frames that serially transfer data between a master device and a slave device.

13. The apparatus of claim 12, further including a plurality of storage devices that operate as logical First-In-First-Out storage media for storage of data that are to be transmitted and data that are received, and wherein the particular task also defines which FIFO or FIFOs are to be used with the particular task.

14. The apparatus of claim 12, further including master state machine and a slave state machine coupled to the task scheduler module, sequencer module and the FIFOs to perform the data transfer, the master state machine utilized when the apparatus is operating in a master mode to generate a clock signal to a slave device and the slave state machine utilized when the apparatus is operating in a slave mode to receive a slave clock from a master device coupled to the apparatus.

15. A method comprising:
programming a plurality of frame definitions in which each frame definition provides signal timing for a corresponding frame used in transferring data;
programming a plurality of instructions, in which each instruction, when executed, obtains a frame definition from the plurality of frame definitions;
programming a plurality of tasks, in which the tasks are used in transferring data, wherein when a particular task is executed, the particular task is to select at least one instruction from the plurality of instructions and use the at least one instruction to obtain one or more frame definitions to establish one or more frames that are used in transferring data in executing the particular task; and
executing the particular task to transfer data.

16. The method of claim 15, wherein the particular task is programmed to have a sequence of instructions that concatenate multiple frame definitions to establish a jumbo frame of multiple frame definitions to transfer data.

17. The method of claim 16, wherein the programmed frame definitions are used to support a plurality of data transfer protocols.

18. The method of claim 17, further including programming an instruction in the plurality of instructions that obtains a frame definition and repeats the obtained frame definition a number of times as specified in the instruction to generate multiple frames, all multiple frames having a same frame definition.

19. The method of claim 18, further including programming the particular task to repeat the sequence of instructions a number of times as specified in the particular task to generate multiple sequence of frames from the repeated sequence of instructions.

20. The method of claim 19, further including programming the particular task to effect data transfer as a master device or a slave device in a master-slave synchronous serial data transfer.
